(19) United States
(12) Patent Application Publication
(10) Pub. No.: US 2008/0204826 A1
(43) Pub. Date: Aug. 28, 2008

(54) Integrated circuit device, circuit board, and electronic instrument

(75) Inventor: Kenji Kimura, Sapporo-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, TOKYO (JP)

(21) Appl. No.: 12/068,564

(22) Filed: Feb. 7, 2008

(30) Foreign Application Priority Data
Feb. 27, 2007 (JP) 2007-046445
Oct. 16, 2007 (JP) 2007-269079

(51) Int. Cl. H04N 1/04

(52) U.S. Cl. 358/497

(57) ABSTRACT

An integrated circuit device includes an analog signal processing section, an A/D converter, a timing generator (including a motor controller), and a memory that stores timing generation setting data. The timing generator generates various driving control signals in synchronization with a shift pulse trigger (TGCK) supplied from a host board, and supplies the driving control signals to a CCD, a motor driver, the analog signal processing section, and the A/D converter.

Japanese Patent Application No. 2007-46445 filed on Feb. 27, 2007 and Japanese Patent Application No. 2007-269079 filed on Oct. 16, 2007, are hereby incorporated by reference in their entirety.

### BACKGROUND OF THE INVENTION

The present invention relates to an integrated circuit device, a circuit board, an electronic instrument, and the like.

In an image sensor such as a CCD or a CMOS sensor used for electronic instruments such as an image reader device, an image signal (stored charge) obtained by a light-receiving section is transferred from the light-receiving section to a transfer section based on a shift signal supplied to the image sensor. The image signal is sequentially shifted by the transfer section based on a driving clock signal, and is output to the outside.

An analog image signal output from the image sensor is input to an analog front-end circuit (AFE), is subjected to specific analog signal processing, and is converted into a digital image signal using an A/D converter. The digital image signal is transmitted to an image processing device controlled by a host CPU.

JP-A-2005-57578 discloses such an analog front-end circuit, for example. The analog front-end circuit disclosed in JP-A-2005-57578 has only an analog signal processing function of adjusting the gain and offset of an analog image signal output from an image sensor.

Since the analog front-end circuit disclosed in JP-A-2005-57578 has only the analog image signal processing function, improvements are required with regard to the following points.

(1) It is necessary to supply an analog image signal to a host CPU after converting the analog image signal into digital data using an A/D converter. The A/D converter is formed using one IC. Therefore, an IC in which the analog front-end circuit is integrated and an IC in which the A/D converter is integrated are required, whereby the number of chips increases.

(2) A timing generator is necessary in order to control the operation timing of each section of the analog front-end circuit, to control the drive timing of the image sensor, and to control drive of a motor which changes the relative positional relationship between the imaging target (document) and the image sensor (e.g., motor which moves a movable carriage provided with the image sensor or paper-feed motor which feeds the imaging target (document)). When providing the timing generator on a host board (board on which the host CPU is mounted), the timing generator must individually supply timing control signals to the analog front-end circuit, the image sensor, and a motor driver. Therefore, the number of signal lines of a communication cable (e.g., serial cable) increases, thereby making it difficult to reduce the size of a scanner device and causing an increase in cost.

(3) In recent years, along with a reduction in size and thickness of a scanner device, there has been a demand for mounting an image sensor and a motor driver on a sub-board (circuit board other than the host board) provided with an analog front-end circuit. To deal with this demand, mounting technology is required which mounts the analog front-end circuit, the image sensor, and the motor driver on the sub-board at a high density while preventing the analog signal processing of the analog front-end circuit from being adversely affected by noise from a motor drive logic circuit.

(4) In the case of (3), it is necessary to extremely efficiently supply various control signals from the timing generator to each of the analog front-end circuit, the image sensor, and the motor driver.

### SUMMARY

According to one aspect of the invention, there is provided an integrated circuit device comprising:

an analog signal processing section that performs signal processing on an analog image signal output from an image sensor and outputs an analog image signal;

an A/D converter that converts the analog image signal output from the analog signal processing section into a digital image signal;

a timing generator that generates and outputs a plurality of control signals; and

at least one memory that stores setting data that is necessary for the timing generator to generate each of the plurality of control signals,

the timing generator generating a control signal of the image sensor among the plurality of control signals based on image sensor setting data stored in the at least one memory, and generating a control signal of a motor driver among the plurality of control signals based on motor driver setting data stored in the at least one memory, the motor driver driving a motor that changes a relative positional relationship between the image sensor and an imaging target.

According to another aspect of the invention, there is provided a circuit board, the above integrated circuit device, an image sensor, and a motor driver being mounted on the circuit board.

According to another aspect of the invention, there is provided an electronic instrument comprising:

a circuit board that includes the above integrated circuit device, an image sensor that is controlled by the control signal output from the integrated circuit device, and at least one motor driver;

at least one motor that is driven by the at least one motor driver, the at least one motor changing a relative positional relationship between the image sensor and an imaging target; and

a host board that includes an image processing section and supplies a reference timing signal to the integrated circuit device, the image processing section processing the digital image data output from the integrated circuit device.

### BRIEF DESCRIPTION OF THE SEVERAL VIEWS OF THE DRAWING

FIG. 1 is a view showing the configuration of an image scanner (example of electronic instrument according to the invention).

FIGS. 2A and 2B are views showing the configuration of an image sensor.

FIG. 3 is a view showing another example of the configuration of a transfer section (shift register).

FIG. 4 is a circuit diagram showing the circuit configuration of an analog signal processing section.

FIG. 5 is a view illustrative of an outline of generation of various timing control signals using a timing generator.

FIG. 6 is a view illustrative of a CCD shift pulse (SH) generation method.

FIG. 7 is a view showing a specific data configuration example of a CCD pattern memory.

FIG. 8 is a view showing the signal waveforms of analog signal processing section control signals and CCD control signals generated based on read setting data.

FIG. 9 is a view schematically showing the signal waveforms of control signals supplied to an image sensor.

FIG. 10 is a view illustrative of an output order of image signals.

FIG. 11 is a view illustrative of an outline of a motor control operation.

FIG. 12 is a view illustrative of generation of motor control signals using a motor controller.

FIG. 13 is a timing chart of various signals (motor clock signal, motor table data, and motor strobe signal) output from a motor controller.

FIG. 14 is a view illustrative of a motor control process.

FIG. 15 is a view showing a specific layout example of an integrated circuit device (IC including an analog front-end circuit AFE).

FIG. 16 is a view illustrative of features of the layout of an integrated circuit device (and a sub-board).

FIG. 17 is a view showing the cross-sectional structure of a sub-board on which an IC and a CCD are mounted.

FIG. 18 is a view showing the configuration of the main portion of an image scanner including an automatic document feeder (ADF).

FIGS. 19A, 19B, and 19C are views illustrative of a method whereby a motor controller supplies motor control signals to a plurality of motor drivers.

### DETAILED DESCRIPTION OF THE EMBODIMENT

The invention has been achieved in view of the above-described consideration. Aspects of the invention may increase the added value of an analog front-end circuit by positively incorporating the functions of other circuits in the analog front-end circuit, for example. Aspects of the invention may also easily deal with a demand for mounting an image sensor and a motor driver on a circuit board provided with an analog front-end circuit, for example. Aspects of the invention may also reduce the number of signal lines of a communication cable, thereby reducing the size and thickness of a scanner device.

(1) According to one embodiment of the invention, there is provided an integrated circuit device comprising:

an analog signal processing section that performs signal processing on an analog image signal output from an image sensor and outputs an analog image signal;

an A/D converter that converts the analog image signal output from the analog signal processing section into a digital image signal;

a timing generator that generates and outputs a plurality of control signals; and

at least one memory that stores setting data that is necessary for the timing generator to generate each of the plurality of control signals,

the timing generator generating a control signal of the image sensor among the plurality of control signals based on image sensor setting data stored in the at least one memory, and generating a control signal of a motor driver among the plurality of control signals based on motor driver setting data stored in the at least one memory, the motor driver driving a motor that changes a relative positional relationship between the image sensor and an imaging target.

Specifically, an analog signal processing section (corresponding to an ordinary analog front-end circuit), an A/D converter, a timing generator, and a memory that stores setting data utilized by the timing generator are integrated in one chip. The timing generator generates an image sensor control signal (generally including an analog signal processing section control signal and an A/D converter control signal; note that the control signal is not limited thereto) and a motor driver control signal. Since the circuits which have been generally provided independently are integrated in one chip, the size and the thickness of a scanner device can be easily reduced. Moreover, since the integrated circuit device includes the timing generator, the control signal can be efficiently supplied to each section. For example, even when mounting a motor driver on the same circuit board as the integrated circuit device, the control signal from the timing generator can be efficiently supplied to the motor driver through the shortest path. Since the integrated circuit device includes the memory that stores the setting data utilized by the timing generator, an external memory need not be provided. This is also advantageous for a reduction in size of a scanner device. Moreover, since the number of signal lines of a communication line (e.g., flexible flat cable (FFC)) that connects a host board (host device) and a sub-board provided with the integrated circuit device can be significantly reduced, signal transmission load is reduced, whereby cost can be reduced. A compact scanner is thus realized.

(2) In the integrated circuit device, the timing generator may control a drive timing of the image sensor and a drive timing of the motor driver using a reference timing signal transmitted from a host as a reference timing.

According to the above configuration, when a host board (host) as a host device supplies the reference timing signal (signal based on which the operation of a scanner device may be controlled; the reference timing signal is referred to as a shift pulse trigger (TGCK) in the invention) to the integrated circuit device, the timing generator included in the integrated circuit device autonomously generates various control signals based on the reference timing signal so that operation control of a scanner device starts. This makes it unnecessary for the host board (host device) to supply various control signals to each section, whereby the number of signal lines of a communication line (e.g., flexible flat cable (FFC)) that connects the host board and the sub-board can be significantly reduced. As a result, signal transmission load is reduced, whereby cost can be reduced. A compact scanner is thus realized.

(3) In the integrated circuit device,

the timing generator may generate a shift pulse based on timing setting information that is included in the image sensor setting data and is based on a reference timing signal transmitted from a host, the shift pulse causing a charge stored in a light-receiving section of the image sensor to be shifted to a transfer section; and

the timing generator may generate a driving clock signal for the image sensor in a driving clock signal generation period, the driving clock signal generation period being set based on the timing setting information based on the reference timing signal.

The timing generator generates a shift pulse (control pulse that causes a charge stored in a light-receiving section of an image scanner to be shifted to a transfer section) and a driving clock signal (e.g., SNCK (φ1 and φ2)) used to transfer the charge based on the reference timing signal (e.g., TGCK). Specifically, the timing of the shift pulse is determined based on the reference timing signal (TGCK) based on the timing setting information read from the memory. Likewise, the generation period of the driving clock signal supplied to a transfer section of the image sensor is determined based on the reference timing signal (TGCK). The driving clock signal (SNCK) for the transfer section of the image sensor is generated in the driving clock signal generation period, and the analog signal processing section control signal and the A/D converter control signal are generated in synchronization with the driving clock signal.

(4) In the integrated circuit device, the integrated circuit device may further include:

a motor driver interface,

the timing generator may read the motor driver setting data from the at least one memory using a request signal that is synchronized with a reference timing signal transmitted from a host; and

the motor driver interface may supply transfer data based on the motor driver setting data read from the at least one memory, a transfer clock signal that is used to transfer the transfer data, and a motor strobe signal that provides a capture timing of the transfer data to the motor driver.

The above configuration gives an example of motor control using the reference timing signal (TGCK). The timing generator reads the motor driver setting data (data necessary for the motor driver to generate various control signals) from the memory using the request signal synchronized with the reference timing signal (TGCK). The motor driver interface supplies the motor driver setting data read from the memory, the synchronization clock signal, and the motor strobe signal to the motor driver, for example. Since the supply timing is synchronized with the reference timing signal (TGCK) supplied from a host board, the rotation of the motor is controlled based on the reference timing signal (TGCK).

(5) In the integrated circuit device, the timing generator may control a plurality of the motor drivers, the timing generator may add identification information of one of the plurality of motor drivers to the motor driver setting data read from the at least one memory and may output the resulting motor driver setting data to each of the plurality of motor drivers.

When one timing generator supplies the control signals to a plurality of motor drivers, if the timing generator supplies the control signals to each motor driver through individual signal paths, the signal paths become complicated. This makes it impossible to deal with a demand for circuit simplification. Therefore, the identification information (ID) that identifies each motor driver is added to the motor driver setting data (common data), and the resulting data is supplied to each motor driver through a common signal path. Each motor driver generates a motor driving signal (phase switch signal) using the received data when the motor driver is specified by the identification information (ID) included in the received data. This makes it possible to utilize a common signal path, whereby load imposed on the timing generator can be reduced when controlling a plurality of motors. Moreover, the circuit configuration is simplified.

(6) In the integrated circuit device, when a direction from a first side of the integrated circuit device toward a second side of the integrated circuit device opposite to the first side is referred to as a first direction and a direction perpendicular to the first direction is referred to as a second direction, the analog signal processing section, the A/D converter, and a host interface that performs an interface process with the host may be disposed along the first direction, and a logic circuit including the timing generator may be disposed in the second direction with respect to the analog signal processing section.

The above configuration gives a preferred layout of each section in the integrated circuit device. Specifically, the analog signal processing system that receives the analog image signal from the image sensor, performs signal processing on the analog image signal, and outputs the resulting signal disposed in an orderly manner along the first direction (direction from the first side toward the second side). The logic circuit section including the timing generator is disposed in the direction (i.e., leftward direction or rightward direction) perpendicular to the arrangement direction of the analog signal processing system with respect to the analog signal processing system. The analog signal processing section system and the logic circuit system can be easily provided at an appropriate distance or an electromagnetic shield can be easily provided by completely separating the analog signal processing section system and the logic circuit system. In the analog signal processing section system, RGB (red, green, and blue) signal processing circuits are generally arranged in parallel. The RGB signal processing paths are linearly disposed at an equal distance by arranging the analog signal processing system in an orderly manner along the first direction, whereby uniform signal processing can be performed for each color. Moreover, since the analog signal processing system is not unnecessarily bent, a compact layout is easily realized.

(7) In the integrated circuit device, a motor driver interface that outputs a signal to the motor driver may be disposed in the second direction with respect to the timing generator.

The motor driver control signal can be removed from a direction differing from the input direction or output direction of the analog image signal by providing the motor driver interface in the second direction with respect to the timing generator, and the motor driver arrangement region on the sub-board (mounting board) can be easily secured. Moreover, adverse effects of noise due to motor drive on the analog signal processing section can be reduced by disposing the motor driver interface apart from the analog signal processing section.

(8) In the integrated circuit device, a noise transmission prevention shield area may be provided between the analog signal processing section and the logic circuit and between the A/D converter and the logic circuit.

The effects of logic noise on the analog signal processing section can be reduced by providing the noise prevention shield area between the analog signal processing section system and the logic circuit system including the timing generator. The shield area may be a ground interconnect, for example, or may be a well region (impurity region) set at a specific potential. A shielding structure may be provided in a package.

(9) In the integrated circuit device,

a terminal that is provided with the analog image signal from the image sensor and a plurality of terminals that output the control signal of the image sensor to the image sensor may be disposed on the first side; and

a terminal that outputs a signal from the host interface to the host may be disposed on the second side.

An image signal output to the host has an extremely high frequency. Therefore, if host terminals are disposed near the analog image signal terminals, noise superimposed on the analog signal increases. Therefore, the effects of noise on the analog signal can be minimized by providing a sufficient distance by disposing the host terminals on the second side and disposing the input/output terminal of the image sensor signal (e.g., analog image signal and control signal) on the first side opposite to the second side.

(10) In the integrated circuit device, terminals among the plurality of terminals that output the control signal of the image sensor may be disposed along the first side, and the remaining terminals among the plurality of terminals that output the control signal of the image sensor may be disposed along a third side or a fourth side that is perpendicular to the first side and the second side.

Since an image sensor (CCD sensor or CMOS sensor) includes a shift register, the image sensor is long in the widthwise direction. Since a large number of control signals are required to shift or transfer a stored charge, the output terminals of the image sensor control signals may not be provided only along the first side of the integrated circuit device. Therefore, the output terminals of the image sensor control signals are also provided along the third side (or fourth side) in addition to the first side. This enables a necessary number of output terminals can be easily disposed effectively utilizing a limited chip size.

(11) According to another embodiment of the invention, there is provided a circuit board, the above integrated circuit device, an image sensor, and a motor driver being mounted on the circuit board.

In the above integrated circuit device, the analog signal processing section, the A/D conversion, and the timing generator that generates various control circuits are integrated in one chip. Therefore, an image sensor and a motor driver can also be efficiently mounted on a single circuit board (mounting board). Since this circuit board is compact and has a high performance, the number of signal lines of a communication line can be reduced. This contributes to a reduction in size and thickness of a scanner.

(12) In the circuit board,

the integrated circuit device and the motor driver may be mounted on a front surface of the circuit board; and

the image sensor may be mounted on a back surface of the circuit board.

A compact circuit board can be realized by mounting the integrated circuit device on the front surface of the circuit board and mounting the image sensor on the back surface of the circuit board. For example, the image sensor and the integrated circuit device can be connected through the shortest path without providing unnecessary interconnects by utilizing conductor layers provided in through-holes.

(13) According to another embodiment of the invention, there is provided an electronic instrument comprising:

a circuit board that includes the above integrated circuit device, an image sensor that is controlled by the control signal output from the integrated circuit device, and at least one motor driver;

at least one motor that is driven by the at least one motor driver, the at least one motor changing a relative positional relationship between the image sensor and an imaging target; and

a host board that includes an image processing section and supplies a reference timing signal to the integrated circuit device, the image processing section processing the digital image data output from the integrated circuit device.

Specifically, the electronic device (scanner device; including a copying machine and a multifunctional facsimile machine) includes the circuit board including the integrated circuit device, the image sensor, and the motor driver, the motor, and the host board that includes the image processing section and outputs a reference timing. The circuit board is compact, and the number of signal lines of a communication line (e.g., serial communication line) that connects each board is small. Therefore, the size and thickness of electronic instruments can be reduced. Moreover, cost can be reduced.

As described above, at least one embodiment of the invention can increase the added value of an analog front-end circuit by positively incorporating the functions of other circuits in the analog front-end circuit, for example. Moreover, it is possible to easily deal with a demand for mounting an image sensor and a motor driver on a circuit board provided with an analog front-end circuit, for example. Furthermore, it is possible to reduce the number of signal lines of a communication cable, thereby reducing the size and thickness of a scanner device.

Preferred embodiments of the invention are described below in detail. Note that the embodiments described below do not in any way limit the scope of the invention defined by the claims laid out herein. Note that all elements of the embodiments described below should not necessarily be taken as essential requirements for the invention.

### First Embodiment

Entire Configuration of Image Scanner

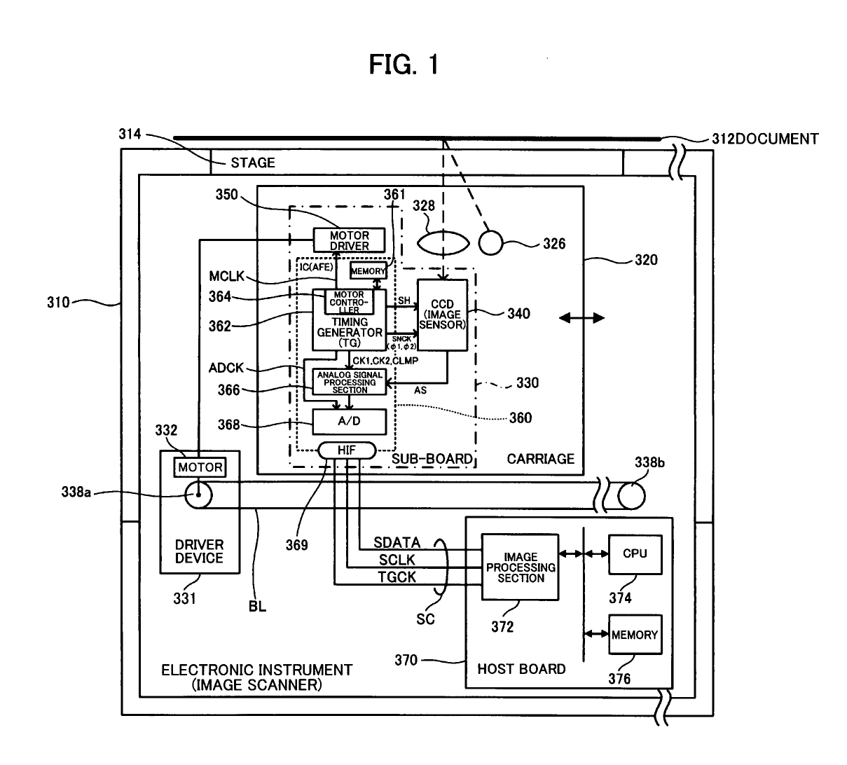

FIG. 1 is a view showing the configuration of an image scanner (example of electronic instrument according to the invention). The term “image scanner” includes a copying machine and a multifunctional facsimile machine.

As shown in FIG. 1, the image scanner 310 includes a movable carriage (hereinafter simply referred to as “carriage”) 320, a driver device 331, and a host board (host) 370. A reading target document 312 is placed on a stage 314.

The carriage 320 is secured on a movable belt (BL). When the movable belt (BL) is moved by a motor 332, a main roller 338a, and a sub-roller 338b, the carriage 320 moves along a document-surface sub-scan direction.

The carriage 320 includes an optical system (including a reading light source 326 and a lens 328), a motor driver 350, and a circuit board (sub-board) 330. The sub-board 330 includes a CCD image sensor (hereinafter referred to as “CCD”; may be a CMOS image sensor) 340 and an integrated circuit device (IC) 360 according to the invention.

The integrated circuit device (IC) 360 includes a multifunctional analog front-end circuit (AFE). Specifically, the analog front-end circuit (AFE) includes an analog signal processing section 366 (portion corresponding to an ordinary AFE) which performs analog signal processing such as correlation double sampling (CDS) and gain control on a signal (AS) captured by the CCD 340, an A/D converter 368, an input/output interface (HIF) 369, a timing generator (TG) 362 including a circuit section which functions as a motor controller 364, and a memory (e.g., SDRAM) 361 which stores various types of setting data based on which timing signals are generated.

The timing generator (TG) 362 supplies a motor clock signal (MCLK) and the like to the motor driver 350, and supplies a shift pulse (SH) and a driving clock signal SNCK (φ1 and φ2) to the CCD 340. The timing generator (TG) 362 supplies a sampling clock signal (CK1 and CK2) and a clamping signal (CLMP) to the analog signal processing section 366, and supplies a timing clock signal (ADCK) to the A/D converter 368.

The motor (e.g., stepping motor) 332 included in the driver device 331 is driven by a driving signal from the motor driver 350 and rotates the main roller 338a.

The host board (host) 370 includes an image processing section 372 which processes a captured image, a CPU 374 which controls the operation timing of the image scanner 310, and a memory 376.

The sub-board 330 and the host board 370 are connected via a serial signal line (e.g., serial cable) SC, for example. Image data (SDATA) and a synchronization clock signal (SCLK) are transferred through the serial signal line SC, for example. A reference timing signal (shift pulse trigger) TGCK is supplied to the sub-board 330 from the host board 370.

The reference timing signal (shift pulse trigger) TGCK is a signal which provides a reference timing when the timing generator (TG) 362 generates various timing control signals.

In an ordinary image sensor, since the host board 370 must individually control the operation of each section, load imposed on the host board 370 increases. Moreover, the amount of communication between the host board 370 and the sub-board 330 increases.

On the other hand, since the image sensor 310 according to the invention is configured so that the host board 370 merely supplies the reference timing signal (shift pulse trigger) TGCK and the timing generator 330 included in the sub-board 330 automatically generates various timing control signals and supplies the generated timing control signals to each section, load imposed on the host board 370 is significantly reduced. Moreover, the amount of communication (i.e., the number of serial signal lines) between the host board 370 and the sub-board 330 is also reduced.

The integrated circuit device shown in FIG. 1 includes the A/D converter 368 and the motor controller 364 (i.e., part of the timing generator (TG) 362) so that the analog front-end circuit (AFE) has multiple functions. Therefore, the size, thickness, and cost of the image scanner 310 can be reduced.

Configuration Example of Image Sensor

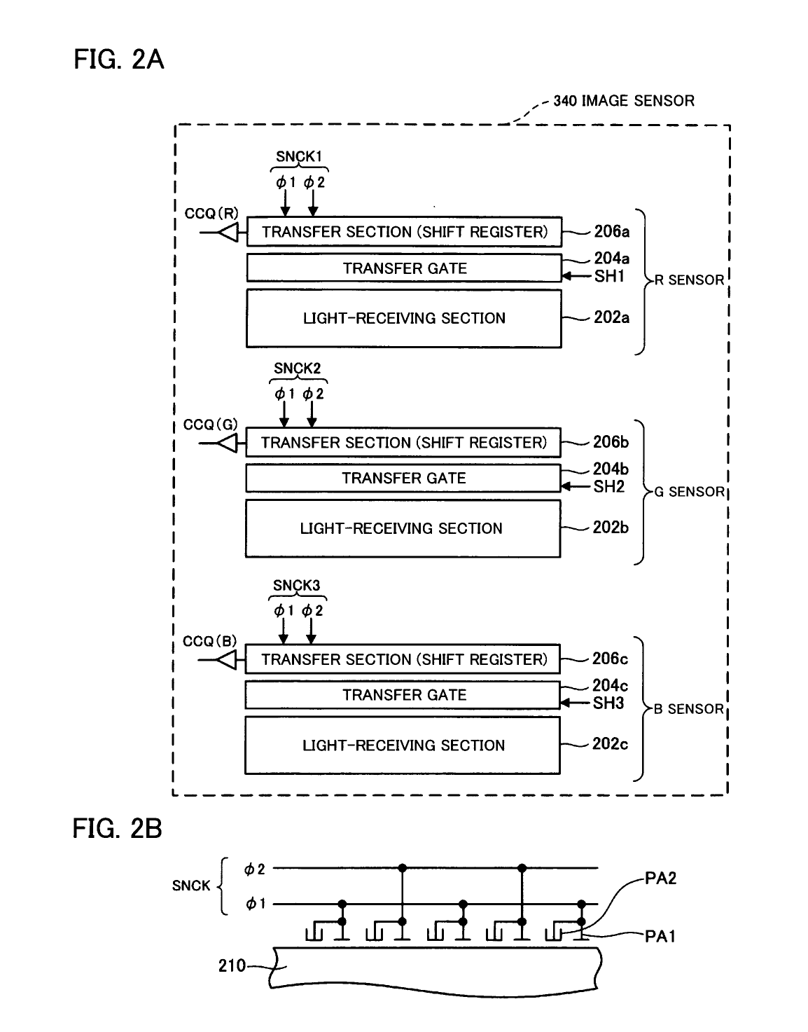

FIGS. 2A and 2B are views showing the configuration of the image sensor. FIG. 2A shows a configuration example of the CCD (image sensor) 340.

As shown in FIG. 2A, the CCD 340 includes a red (R) sensor, a green (G) sensor, and a blue (B) sensor (i.e., three channels), for example. Each sensor has an identical configuration.

The sensor of each color includes a light-receiving section 202 (202a to 202c), a transfer gate 204 (204a to 204c), and a transfer section (shift register) 206 (206a to 206c).

The light-receiving section 202 (202a to 202c) includes a plurality of light-receiving elements (photodiodes or pixels) which perform photoelectric conversion. Each light-receiving element (pixel) of the light-receiving section 202 (202a to 202c) produces and stores a charge corresponding to the amount of received light. The shift signal SH (SH1 to SH3) becomes active after a specific period of time required for charge storage has expired, whereby the transfer gate 204 (204a to 204c) is turned ON. As a result, the stored charge is transferred to the shift register (shift register provided corresponding to each light-receiving element) of the transfer section 206 (206a to 206c) through the transfer gate 204 (204a to 204c).

The stored charge (image signal) is transferred to the adjacent shift registers based on the two-phase driving clock signals φ1 and φ2 (hereinafter collectively referred to as “SNCK”). An image signal corresponding to the charge stored in each light-receiving element is serially output from a CCQ terminal of the transfer section (shift register) 206 (206a to 206c).

FIG. 2B is a view showing an example of the cross-sectional device structure of the transfer section 206 (206a to 206c). Transfer electrodes PA1 and PA2 are provided on a semiconductor substrate 210. Each transfer electrode is driven by the driving clock signal SNCK (two-phase clock signals φ1 and φ2). A potential well is formed on the surface of the semiconductor substrate 210, and a signal charge is transferred in a specific direction due to a change in depth of the potential well.

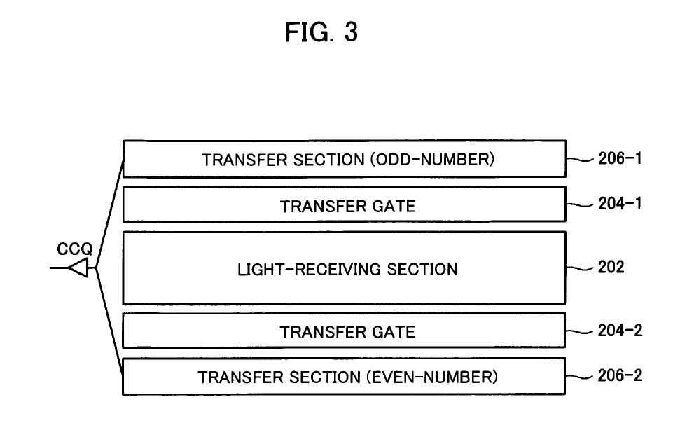

FIG. 3 is a view showing another example of the configuration of the transfer section (shift register). The configuration of the CCD is not limited to the configuration shown in FIG. 2A. Various modifications may be made. In FIG. 3, a transfer gate 204-1 and a transfer section 206-1 for odd-numbered pixels and a transfer gate 204-2 and a transfer section 206-2 for even-numbered pixels are provided. In FIG. 3, it is also preferable to provide the light-receiving sections, the transfer gates, and the transfer sections for reading R (red), G (green), and B (blue) images.

Configuration of Analog Signal Processing Section

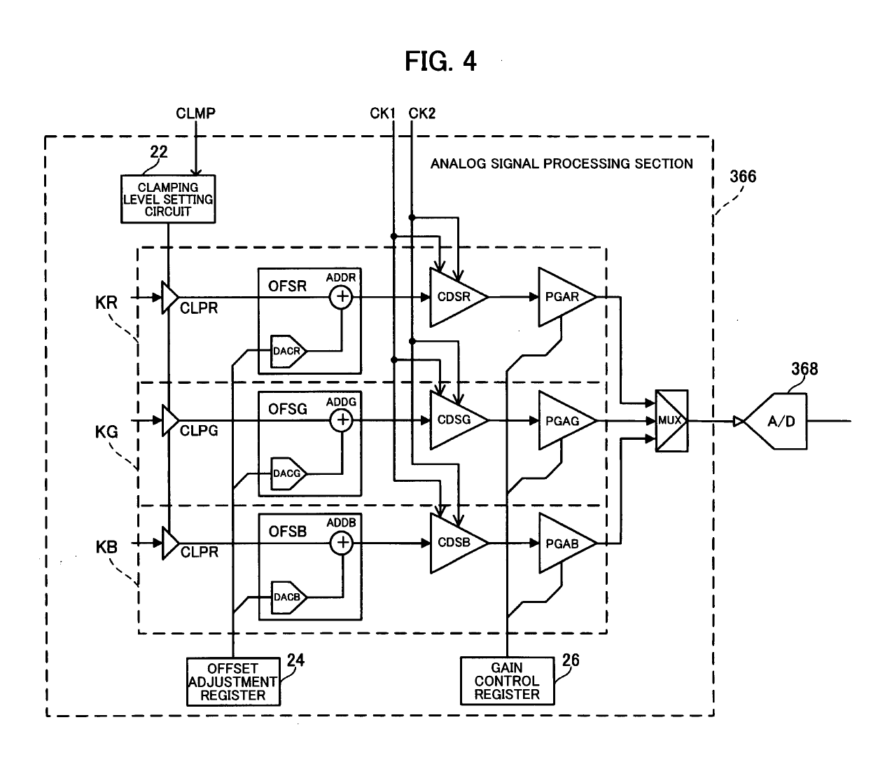

FIG. 4 is a circuit diagram showing the circuit configuration of the analog signal processing section. The configuration of the analog signal processing section 366 is not limited to the configuration shown in FIG. 4. Various modifications may be made such as omitting some elements.

The analog signal processing section 366 includes R, G and B clamping circuits CLPR, CLPG, and CLPB. The clamping circuits CLPR, CLPG, and CLPB clamp the levels of R, G, and B image signals at a clamping level set by a clamping level setting circuit 22. The clamping timing is determined by the control signal (CLMP) from the timing generator (TG) 362.

The analog signal processing section 366 includes R, G, and B offset adjustment circuits (OFSR, OFSG, and OFSB). The offset adjustment circuits (OFSB, OFSR, and OFSG) respectively include R, G, and B D/A converters (DACR, DACG, and DACB) and analog adder circuits (ADDR, ADDG, and ADDB). An offset is adjusted based on offset adjustment data set in an offset adjustment register 24.

The analog signal processing section 366 includes R, G, and B correlation double sampling circuits (CDSR, CDSG, and CDSB). The sampling timing is determined by the sampling clock signal (CK1 and CK2) from the timing generator (TG) 362.

The analog signal processing section 366 includes R, G, and B gain control amplifiers PGAR, PGAG, and PGAB. The gain control amplifiers (PGAR, PGAG, and PGAB) control the gain based on gain control data set in a gain control register 26.

The analog signal processing section 366 includes a multiplexer MUX. The R, G, and B image signals can be A/D-converted by time division using a high-speed A/D converter 368 by providing the multiplexer MUX.

Outline of Timing Generation of Timing Generator

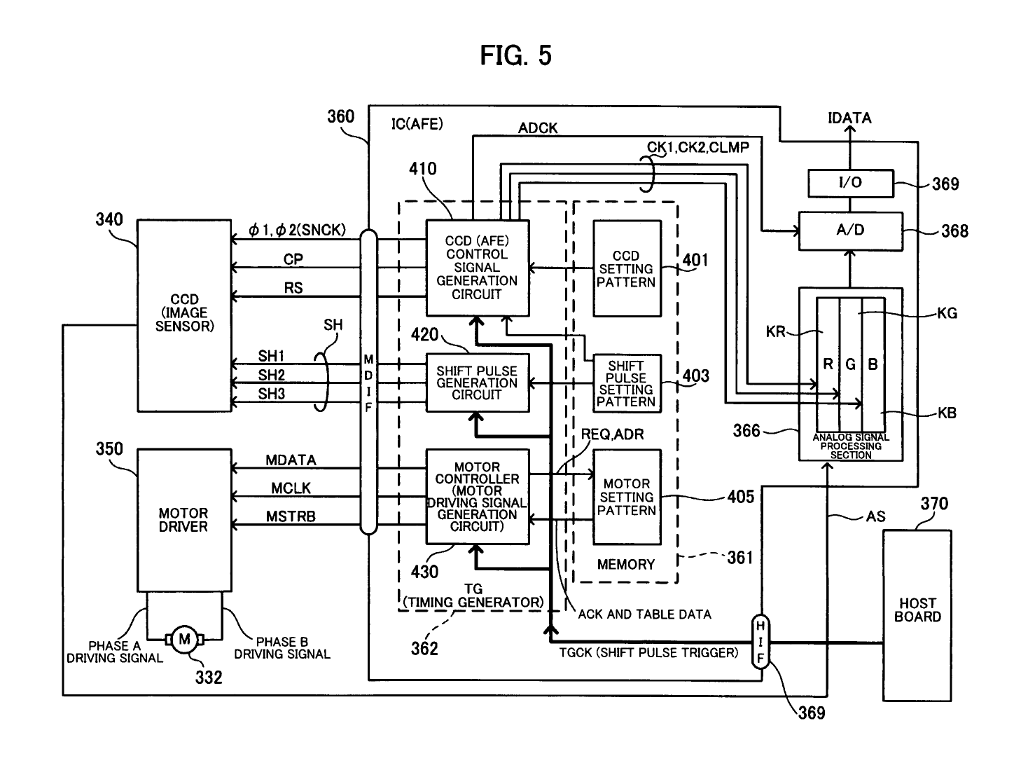

FIG. 5 is a view illustrative of an outline of generation of various timing control signals using the timing generator. In FIG. 5, the same sections as in FIG. 1 are indicated by the same reference symbols.

As shown in FIG. 5, a timing generator (TG) 430 included in the integrated circuit device (IC: with built-in AFE circuit) includes a CCD (AFE) control signal generation circuit 410, a shift pulse generation circuit 420, and a motor controller (motor driving signal generation circuit) 430.

A memory 361 includes setting data based on which various timing control signals are generated, that is, a CCD setting pattern 401, a shift pulse setting pattern 403, and a motor setting pattern 405.

The reference timing signal TGCK (shift pulse trigger) from the host board (host) 370 is supplied to the timing generator (TG) 430. The reference timing signal TGCK is input to the timing generator (TG) 362 via an interface (HIF) provided in the integrated circuit device 360.

The timing generator (TG) generates various control signals using the reference timing signal TGCK (shift pulse trigger) as a reference timing. Therefore, it suffices that the host board 370 merely transmit the reference timing signal TGCK to the timing generator (TG) mounted on the sub-board 330, whereby load imposed on the host board 370 (host device) is significantly reduced, and the amount of communication is also reduced.

The CCD (AFE) control signal generation circuit 410 reads the CCD setting pattern 401 from the memory 361 in synchronization with the reference timing signal TGCK, and generates the driving clock signal SNCK (φ1 and φ2), the clamping signal (CP), the reset signal (RS), the A/D converter timing clock signal (ADCK), the sampling clock signal (CK1 and CK2), and the clamping signal (CLMP) based on the CCD setting pattern 401.

The shift pulse generation circuit 420 reads the shift pulse setting pattern 403 from the memory 361 in synchronization with the reference timing signal TGCK, and generates the shift pulse SH (SH1 to SH3) based on the shift pulse setting pattern 403.

The motor controller 430 transmits an address (ADR) and a setting data read request (REQ) to the memory 361 in synchronization with the reference timing signal TGCK. The memory 361 transmits an acknowledge (ACK) and table data (motor setting data) to the motor controller 430 in response to the request (REQ).

The motor controller 430 generates motor data (MDATA), the motor clock signal (MCLK), and a motor strobe signal (MSTRB) based on the table data (motor setting data). The motor driver 350 supplies two-phase driving signals (phase A and phase B driving signals) to the stepping motor (M) 332.

The driving clock signal SNCK (φ1 and φ2), the clamping signal (CP), the reset signal (RS), the A/D converter timing clock signal (ADCK), the sampling clock signal (CK1 and CK2), the clamping signal (CLMP), the shift pulse SH (SH1 to SH3), the motor data (MDATA), the motor clock signal (MCLK), and the motor strobe signal (MSTRB) are supplied to the CCD (image sensor) 340 or the motor driver 350 via the input/output interface (MDIF: the MDIF also serves as a motor driver interface) of the integrated circuit device 360. The timing clock signal ADCK is supplied to the A/D converter 368 via a signal line provided in the integrated circuit device 360. The sampling clock signals CK1 and CK2 and the clamping signal CLMP are supplied to the analog signal processing section 366.

The analog signal processing section 366 includes signal processing systems KR, KG, and KB for respective colors (R, G, and B). Each signal processing system performs analog signal processing on a color image signal from the CCD 340. A signal output from the analog signal processing section 366 is converted into a digital image signal using the A/D converter 368. A digital image signal IDATA is output from the input/output section (I/O) 369.

Shift Pulse (SH) Generation Timing and Data Transfer Timing

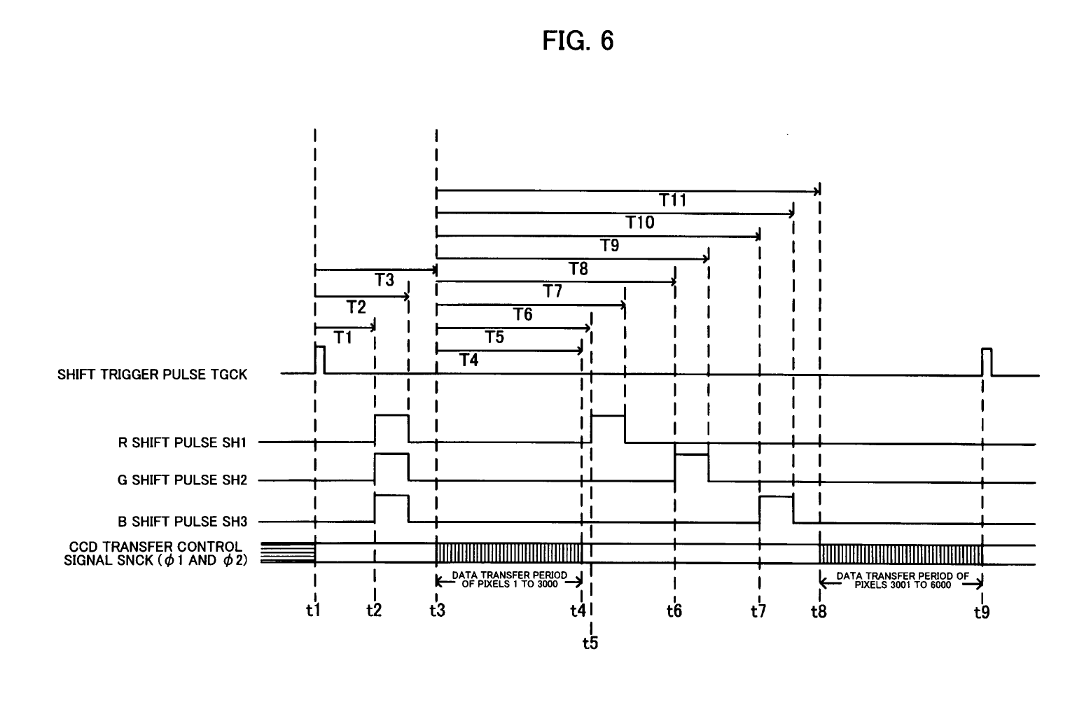

FIG. 6 is a view illustrative of a CCD shift pulse (SH) generation method. As shown in FIG. 6, the CCD setting pattern 401 shown in FIG. 5 includes data (T1, T2, T6, T7, T8, T9, and T10) which determines the generation timing of the shift pulse (SH) based on the reference timing signal TGCK (shift pulse trigger).

In FIG. 6, when the reference timing signal TGCK has been input at a time t1, the shift pulse (SH1 to SH3) of each color is generated between a time t2 when a period T2 has expired after the time t1 and a time t3 when a period T3 has expired after the time t1. A second shift pulse SH1 is generated at a time t5 when a period T6 has expired after the time t3, a second shift pulse SH2 is generated at a time t6 when a period T8 has expired after the time t3, and a second shift pulse SH3 is generated at a time t7 when a period T10 has expired after the time t3.

The transfer period of pixel data in the CCD is determined based on the input timing t1 of the reference timing signal TGCK. Specifically, the data transfer period of pixels 1 to 3000 is a period between the time t3 when the period T3 has expired after the time t1 and a time t4 when a period T5 has expired after the time t3, for example. Likewise, the data transfer period of pixels 3001 to 6000 is a period between a time t8 when a period T11 has expired after the time t3 and a time t9, for example. In the pixel data transfer period, the image data is sequentially transferred through the shift register based on the CCD transfer control signal SNCK (φ1 and φ2) synchronized with the reference timing signal TGCK. Since the image transfer period is determined based on the reference timing signal TGCK and the image data is transferred in the image transfer period based on the CCD transfer control signal SNCK synchronized with the reference timing signal TGCK, the image data is transferred in synchronization with the reference timing signal TGCK.

Specific Data Configuration of CCD Pattern Memory

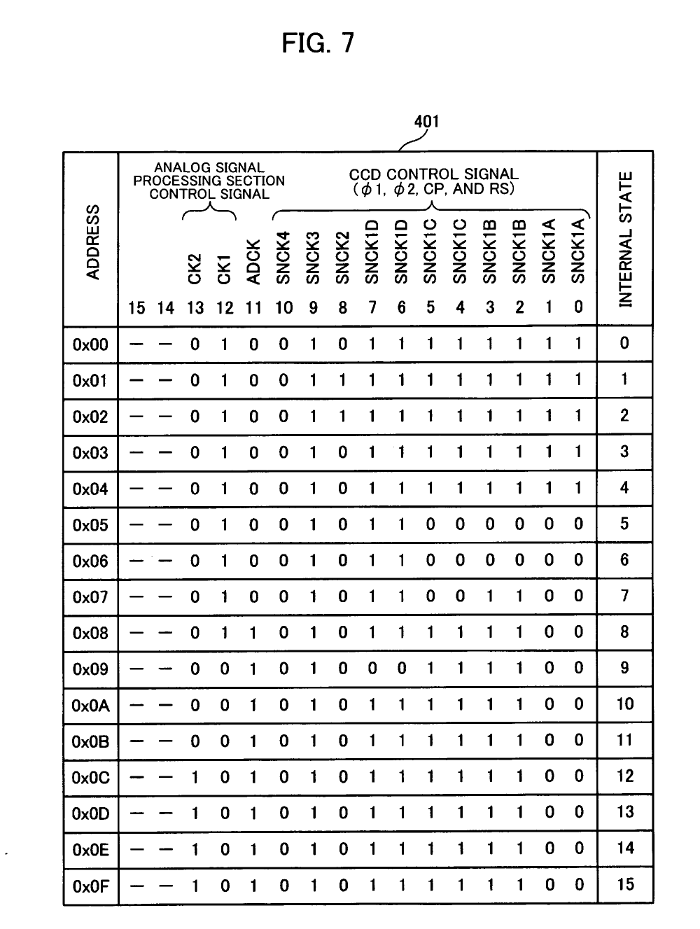

FIG. 7 is a view showing a specific data configuration of the CCD pattern memory 401. As shown in FIG. 7, internal states 0 to 15 are set corresponding to addresses (0x00 to 0x0F). Pattern data for generating the analog signal processing section control signals (CK1, CK2, and ADCK) and pattern data for generating the CCD control signals (φ1, φ2, CP, and RS) are set in units of the internal states 0 to 15.

The setting data is read in the order from the internal state 0 to the internal state 15. In the next cycle, the setting data is again read in the order from the internal state 0 to the internal state 15. The period required to read the setting data of the internal states 0 to 15 corresponds to one pixel period.

Note that “0” corresponding to each internal state indicates that the timing control signal to be generated is set at a low level, and “1” indicates that the timing control signal to be generated is set at a high level.

Signal Waveform of Control Signal

The setting data is read from each address of the memory 361 each time the value of the internal state is incremented in the order from 0 to 15, and the analog signal processing section control signals (CK1, CK2, and ADCK) and CCD control signals (φ1, φ2, CP, and RS) are generated based on the read setting data.

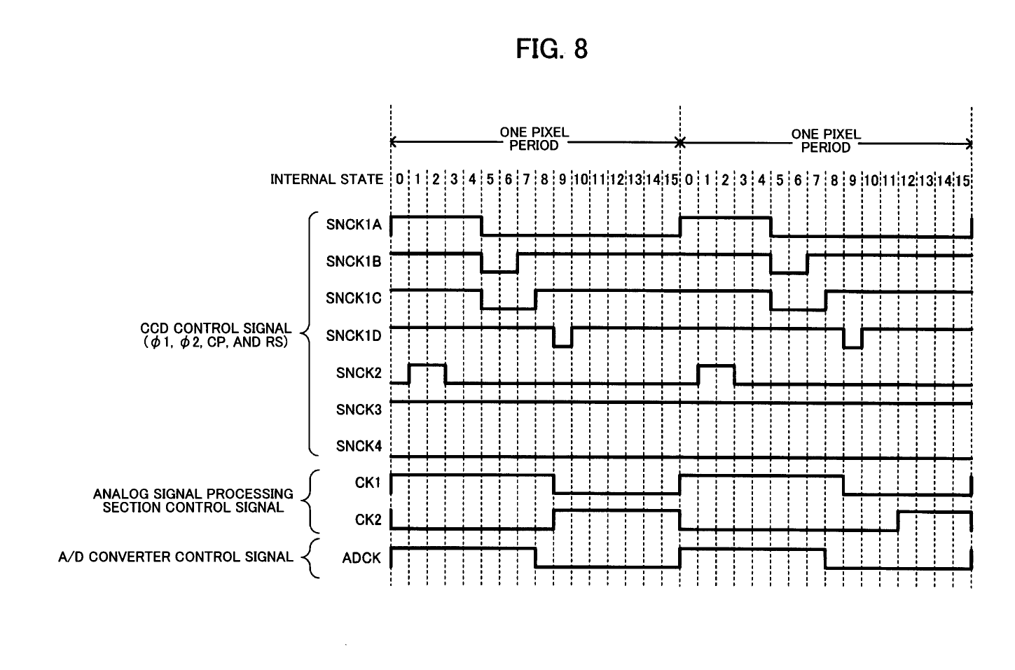

FIG. 8 is a view showing the signal waveforms of the analog signal processing section control signals (CK1, CK2, and ADCK) and CCD control signals (φ1, φ2, CP, and RS) generated based on the read setting data (data shown in FIG. 7).

For example, the data pattern of the internal state 0 shown in FIG. 7 is (11111111010010) (from right to left). The signal is set at a high level when the data is “1”, and is set at a low level when the data is “0”. The signal waveforms of one pixel shown in FIG. 8 are generated by applying the above rule to each of the internal states 0 to 15. The signal waveforms of the next pixel are similarly generated.

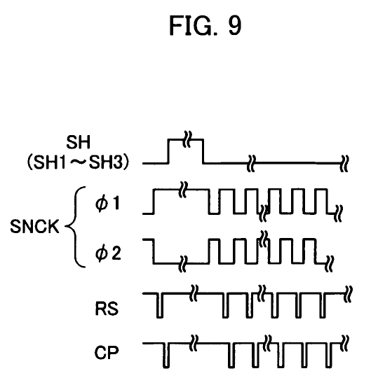

FIG. 9 is a view schematically showing the signal waveforms of the control signals (SH, φ1, φ2, RS, and CP) supplied to the image sensor. These signals are generated using the reference timing signal TGCK as a reference timing, as described with reference to FIG. 6.

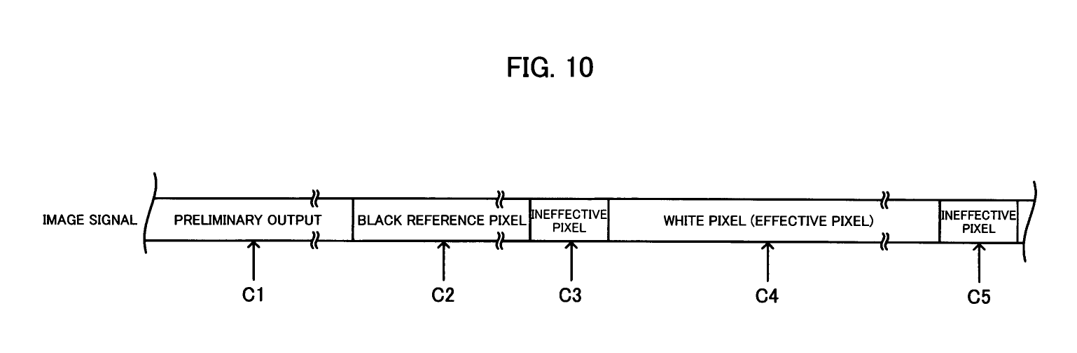

The output order of the captured image signals is briefly described below. FIG. 10 is a view illustrative of the output order of the image signals.

After preliminary output has been performed, as indicated by C1 in FIG. 10, an image signal of a black reference pixel (optical black or optical shield output) is output, as indicated by C2. An image signal of an ineffective pixel is then output, as indicated by C3. An image signal of a white pixel (effective pixel) is then output, as indicated by C4, and an image signal of an ineffective pixel is output, as indicated by C5.

Outline of Motor Control Operation and Generation of Motor Control Signal

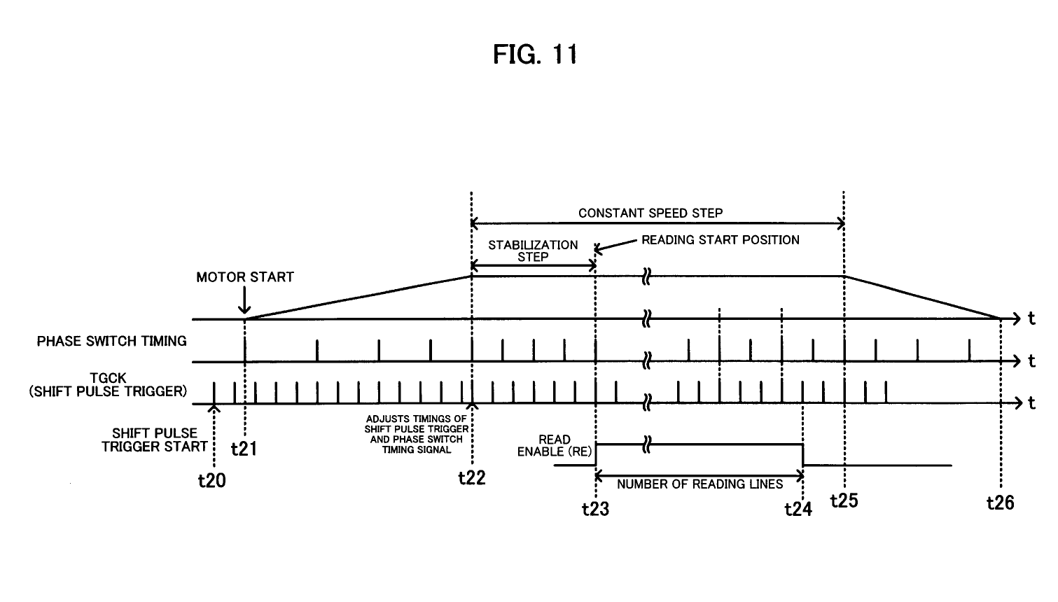

An outline of the motor control operation and generation of motor control signals are described below. FIG. 11 is a view illustrative of an outline of the motor control operation.

As shown in FIG. 11, when the shift pulse trigger (TGCK) has been input to the timing generator (TG) 362 at a time t20, the motor starts to rotate at a time t21. A Hall element (not shown) which detects the rotation position of the motor is provided in the motor (M) 332. A phase switch timing signal is periodically obtained from the Hall element.

The phase switch timing signal is always input to the host board 370, for example. Therefore, the CPU 374 mounted on the host board 370 can monitor the rotation state of the motor (M) 332.

A period between times t20 and t22 is a motor acceleration period. The phase switch timing signal is not synchronized with the shift pulse trigger (TGCK) in this period. A period between times t22 and t25 is a constant speed period. The host board 370 synchronizes the shift pulse trigger (TGCK) with the phase switch timing signal at the time t22 using a phase-locked loop (PLL), for example (i.e., adjusts the timings of the shift pulse trigger (TGCK) and the phase switch timing signal). Therefore, the rotation phase of the motor (M) 332 can be controlled based on the timing of the shift pulse trigger (TGCK) in the period between the times t22 and t25.

A period between times t22 and t23 is a motor rotation stabilization period. A read enable (RE) becomes active at the time t23, whereby reading of the document 312 (see FIG. 1) commences. Reading of the document ends at a time t24.

A period between times t25 and t26 is a deceleration period of the motor (M) 332. The motor (M) 332 stops at the time t26.

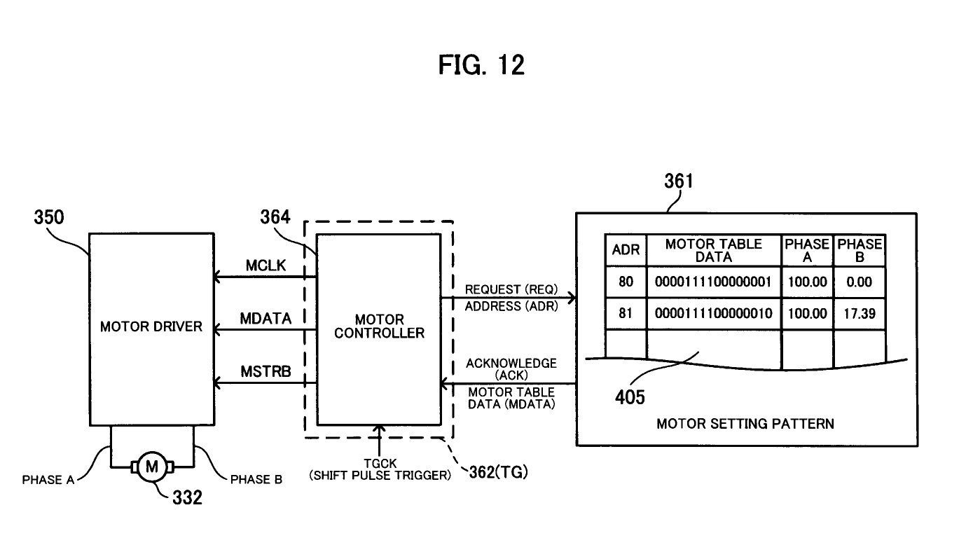

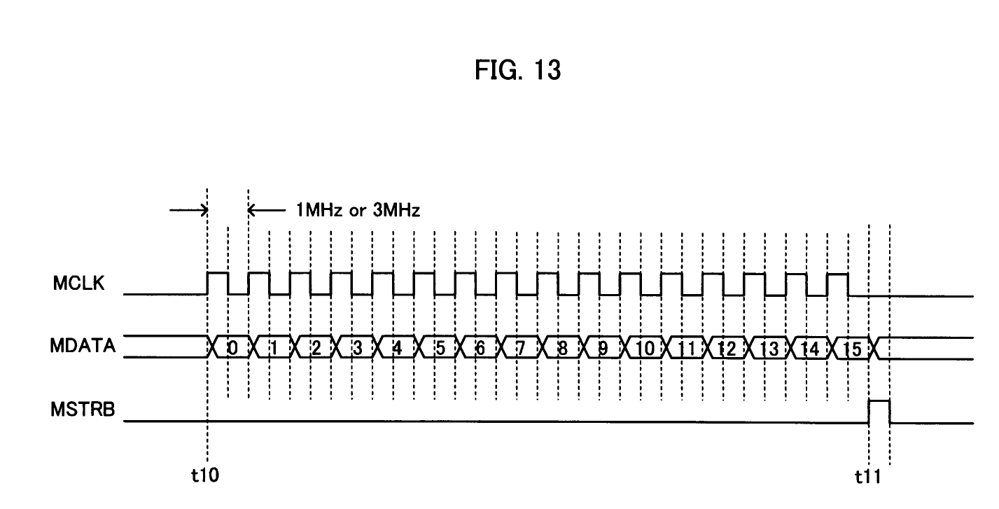

Generation of the motor control signals using the timing generator (TG) 362 is described below. FIG. 12 is a view illustrative of generation of the motor control signals using the motor controller 364 (part of the timing generator (TG)). FIG. 13 is a timing chart of various signals (motor clock signal, motor table data, and motor strobe signal) output from the motor controller.

As shown in FIG. 12, the motor setting pattern 405 is stored in the memory 361. In the motor setting pattern 405, the motor table data (including data relating to two-phase driving signals (phase A and phase B) of the motor) is set corresponding to an address (ADR). The motor table data refers to setting data for the motor (M) 332.

For example, “0000111100000001”, phase A data “100.00”, and phase B data “0.00” are set at an address (ADR) 80.

The motor controller 364 transmits a request (REQ) and an address (ADR) to the memory 361 in synchronization with the shift pulse trigger (TGCK). The memory 361 transmits an acknowledge (ACK) and motor table data (MDATA) to the motor controller 364.

The motor controller 364 transmits the motor table data (MDATA), the motor clock signal (synchronization clock signal), and the motor strobe signal (MSTRB: signal which provides a timing at which the motor driver 350 captures the motor setting data) to the motor driver 350 in synchronization with the shift pulse trigger (TGCK).

As shown in the timing chart in FIG. 13, the frequency of the motor clock signal MCLK is 1 MHz or 3 MHz, for example. The first motor table data is output at a time t10. The motor strobe signal (MSTRB) becomes active at a time t11. The motor driver 350 captures the motor table data (MDATA) at this timing.

The motor driver 350 captures the motor table data (MDATA) based on the motor strobe signal (MSTRB), and generates the two-phase motor driving signals (phase A driving signal and phase B driving signal) to drive the motor (M) 332.

FIG. 14 summarizes the above-described motor control. FIG. 14 is a view illustrative of the motor control process.

As shown in FIG. 14, in the motor acceleration period, the motor controller 364 outputs a request (REQ) 1A and an address (ADRR) 1B, and the memory 361 returns an acknowledge (ACK) 1C and motor table data (MDATA) 1D, for example. The two-phase motor driving signals (phase A driving signal and phase B driving signal) are generated based on the above operation. The above operation is repeated.

In the constant speed period, the motor controller 364 outputs a request (REQ) 2A and an address (ADRR) 2B, and the memory 361 returns an acknowledge (ACK) 2C and motor table data (MDATA) 2D, for example.

The motor table data (MDATA) 2D is then periodically supplied to the motor driver 350 from the motor controller 364. The motor driver 350 generates the two-phase motor drive signals (phase A driving signal and phase B driving signal) based on the motor table data (MDATA).

Layout of Integrated Circuit Device

A preferred layout configuration of the integrated circuit device (IC including the analog front-end circuit AFE) 360 mounted on the sub-board 330 is described below.

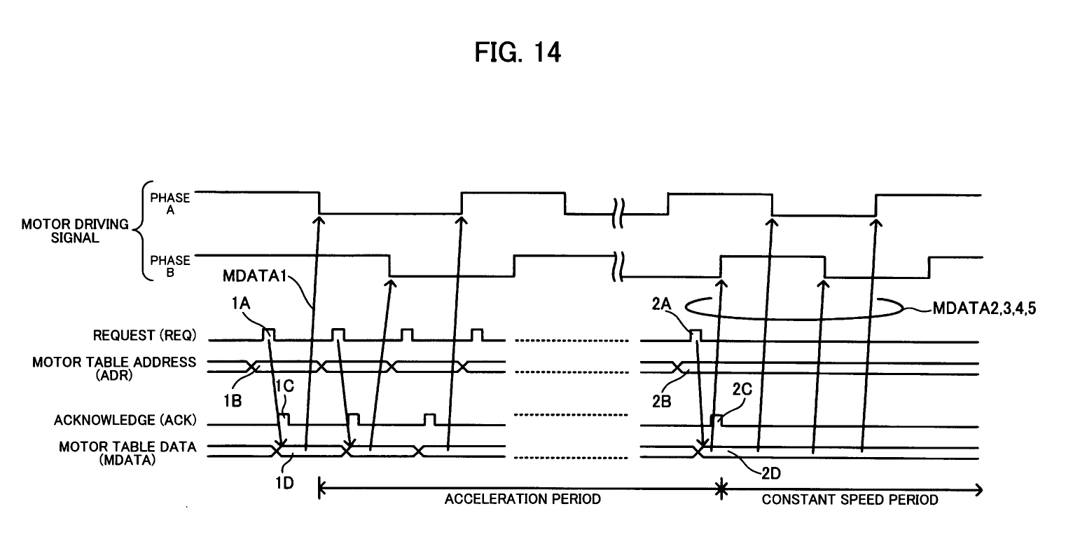

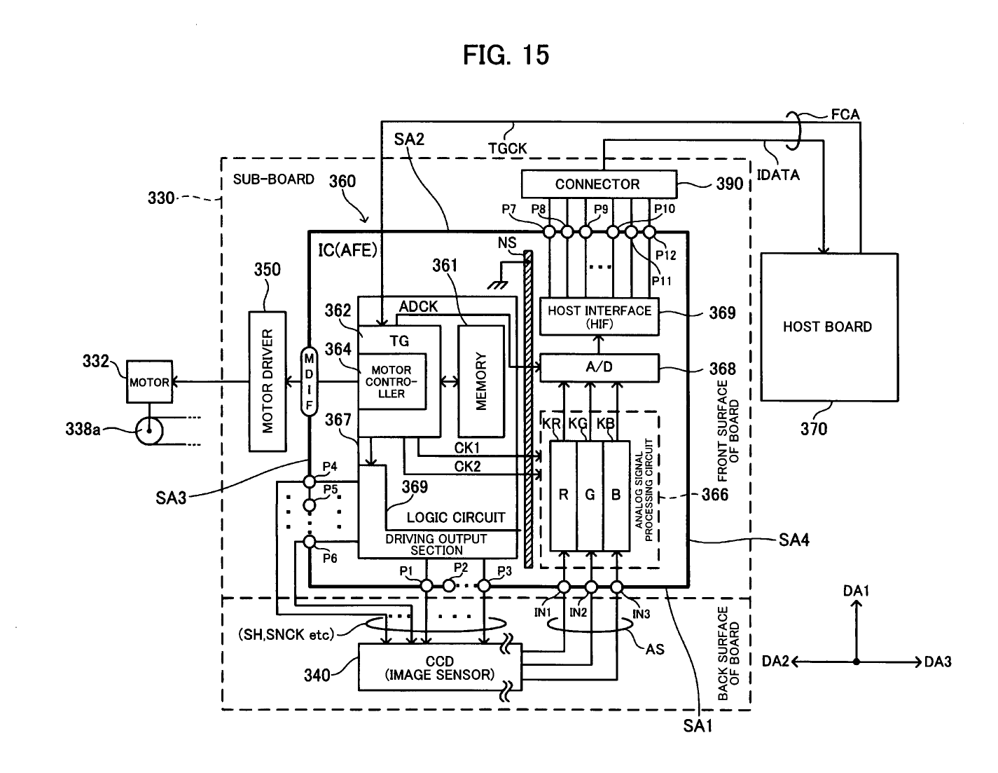

FIG. 15 is a view showing a specific layout example of the integrated circuit device (IC including the analog front-end circuit AFE). In FIG. 15, the same sections as in other drawings are indicated by the same reference symbols. The main elements integrated in the integrated circuit device (IC) 360 are the same as the elements shown in FIG. 1.

The integrated circuit device (IC) 360 is mounted on the front surface of the sub-board 330. The CCD (image sensor) is connected to the back surface of the sub-board 330. This enables the IC and the CCD to be compactly integrated on one circuit board. The cross-sectional structure of the sub-board is described later with reference to FIG. 17.

The integrated circuit device (IC) 360 includes a plurality of terminals (P1 to P3, P4 to P6, P7 to P12, and IN1 to IN3). The integrated circuit device (IC) 360 includes a host interface (HIF) 369 for communicating with the host board 370. The integrated circuit device (IC) 360 includes a motor interface (MDIF) for communicating with the motor driver 350.

A connector 390 connected with a serial communication line used to communicate with the host board 390, and the motor driver 350 are mounted on the sub-board 330.

The lower side of the integrated circuit device (IC) is referred to as a first side (SA1), the upper side opposite to the first side (SA1) is referred to as a second side (SA2), the left side perpendicular to the first and second sides (SA1 and SA2) is referred to as a third side (SA3), and the right side perpendicular to the first and second sides (SA1 and SA2) and opposite to the third side (SA3) is referred to as a fourth side (SA4).

A direction from the first side (SA1) toward the second side (SA2) is referred to as a first direction (DA1), and directions perpendicular to the first direction (DA1) are referred to as second directions (DA2 and DA3). The second direction toward the left is referred to as DA2, and the second direction toward the right is referred to as DA3 for convenience of description.

The integrated circuit device (IC) 360 is separated by a GND wire (NS) which functions as a noise transmission prevention shield area. The analog signal processing section 366, the A/D converter 368, and the host interface (HIF) are disposed in the right area along the first direction (direction DA1).

A logic circuit 367 including the timing generator (TG) and the memory 361 is disposed in the left area with respect to the GND wire (NS).

The motor controller 364 is disposed near the third side (SA3). The motor control signals (MCLK, MDATA, and MSTRB) are output along the direction DA2 to the motor driver 350 disposed in the direction DA2 with respect to the motor controller 364.

The terminals (P1 to P3) used to communicate with the CCD (image sensor) 340 are provided along the first side (SA1). The remaining terminals (P4 to P6) used to communicate with the CCD (image sensor) 340 are provided along part of the third side (SA3). Since the number of terminals of the CCD (image sensor) 340 is large, the number of signal lines inevitably increases. Since the number of terminals which can be disposed is limited when disposing the terminals along only the first side (SA1), the terminals are partially disposed along part of the third side (SA1). This enables a large number of terminals to be disposed without unnecessarily increasing the area.

### Second Embodiment

This embodiment illustrates the features of the layout of the integrated circuit device and the sub-board.

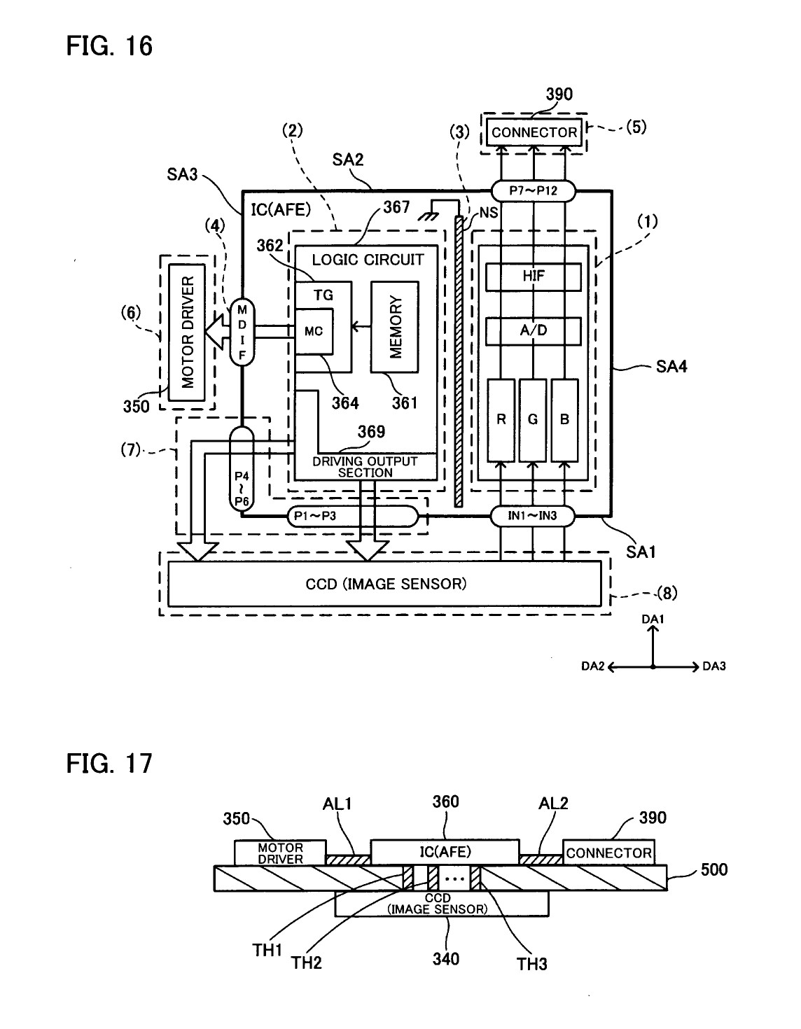

FIG. 16 is a view illustrative of the features of the layout of the integrated circuit device (and the sub-board). In FIG. 16, characteristic configurations are indicated by (1) to (8).

(1) The analog signal processing circuit blocks (analog signal processing section 366, A/D converter 368, and host interface (HIF)) are separated from the logic circuit 367 and are linearly arranged along the direction SA1. According to this layout, the distance between each circuit and the logic circuit 367 can be sufficiently increased. Moreover, the noise transmission prevention shield area (NS) can be easily provided. Therefore, the effects of logic noise can be reduced. The RGB signal lines can be made linear, and the lengths of the signal lines can be easily made uniform. Therefore, the amount of signal delay of each color can be made uniform.

(2) The logic circuit 367 is collectively disposed at a position separate from the analog signal processing circuit block. Therefore, the effects of logic noise on the analog signal processing section can be reduced.

(3) The shield area (NS) is provided. Therefore, electromagnetic noise can be absorbed, whereby the effects of logic noise on the analog signal processing section can be reduced.

(4) The motor interface (MDIF) can be easily disposed without reducing the arrangement space of the analog image signal and digital image signal input/output terminals by providing the motor interface (MDIF) near the third side (SA3). Moreover, the motor interface (MDIF) can be provided at a position apart from the analog signal processing section 366. Therefore, noise due to motor drive adversely affects the analog signal processing section 366 to only a small extent.

(5) The connector 390 is provided opposite to the terminals (P7 to P12). Therefore, the lengths of interconnects which connect the terminals (P7 to P12) and the connector 390 can be minimized. Since the frequency of the image signal communicated through the connector is extremely high, high-frequency noise may occur. The connector 390 is disposed apart from the logic circuit 367. Therefore, the logic circuit 367 is rarely affected by high-frequency noise.

(6) The motor driver 350 is disposed in the direction DA2 with respect to the integrated circuit device 360. The motor driver 350 is a high-power IC and easily produces electromagnetic noise. Since the motor driver 350 is disposed apart from the analog signal processing system, the analog signal processing system rarely affected by electromagnetic noise.

(7) The terminals (P1 to P3) used to communicate with the CCD (image sensor) 340 are provided along the first side (SA1). The remaining terminals (P4 to P6) are disposed along part of the third side (SA3). Since the number of terminals of the CCD (image sensor) 340 is large, the number of signal lines inevitably increases. Since the number of terminals which can be disposed is limited when disposing the terminals along only the first side (SA1), the terminals are partially disposed along part of the third side (SA1). This enables a large number of terminals to be disposed without unnecessarily increasing the area.

(8) Since the CCD (image sensor) 340 is disposed on the back surface of the sub-board 330 (circuit board), the space of the circuit board can be utilized efficiently. Therefore, a compact circuit board (sub-board 330) can be realized.

The above description has been given on the assumption that the analog signal processing section 366 is disposed on the right of the chip and the logic circuit 367 is disposed on the left of the chip. Note that the invention is not limited thereto. The positional relationship between the analog signal processing section 366 and the logic circuit 367 may be reversed. In this case, the third side (SA3) in the above description may be appropriately replaced with the fourth side (SA4).

FIG. 17 is a view showing the cross-sectional structure of the sub-board 330 on which the IC and the CCD are mounted. The integrated circuit device (IC including the analog front-end circuit AFE) 360, the motor driver 350, and the connector 390 are mounted on the front surface of a board main body 500. The integrated circuit device (IC) 360 and the motor driver 350 are connected via an interconnect AL1. The integrated circuit device (IC) 360 and the connector 390 are connected via an interconnect AL2.

The CCD (image sensor) 340 is mounted on the back surface of the board main body 500. The integrated circuit device (IC) 360 and the CCD (image sensor) 340 are connected through conductor layers provided in through-holes TH1 to TH3 formed through the board main body 500.

### Third Embodiment

This embodiment illustrates a method of transmitting the control signals (MCLK, MDATA, and MSTRB) from the motor controller to the motor driver when driving a plurality of motors.

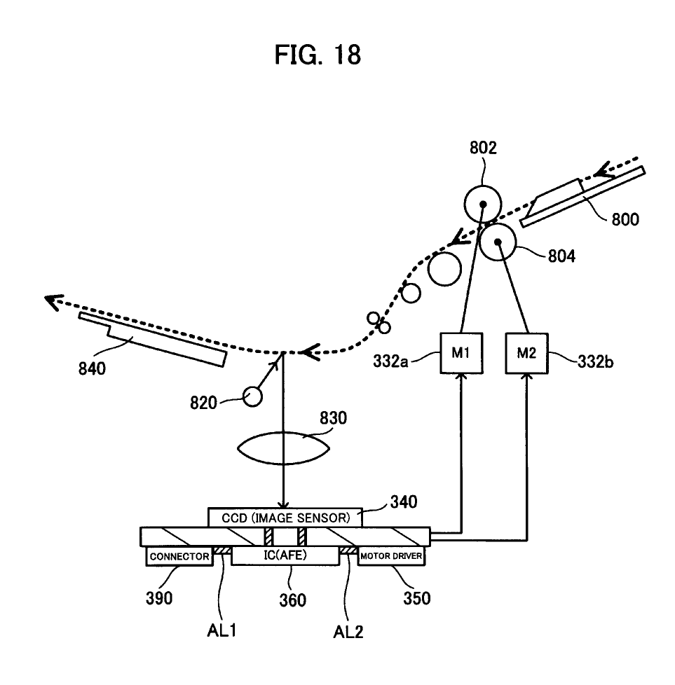

FIG. 18 is a view showing the configuration of the main portion of an image scanner including an automatic document feeder (ADF). The image scanner according to the above embodiment (FIG. 1) moves the CCD along the surface of the document. In the image scanner according to this embodiment (FIG. 18), a document is moved using the ADF, and the document is read during movement. In each case, the motor changes the relative positional relationship between the document (reading target) and the CCD (image sensor).

The document provided on a document tray 800 is transported in the direction indicated by a dotted arrow in FIG. 18 using paper feed rollers 802 and 804. The paper feed rollers 802 and 804 are respectively driven by motors M1 and M2 (332a and 3332b).

A sub-board having a cross-sectional structure shown in FIG. 17 is provided in the image scanner shown in FIG. 18. Light emitted from a light source 820 and reflected by the document is condensed by a lens 30 and is imaged on a light-receiving surface of the CCD (image sensor) 340. The read document is placed in a storage tray 840.

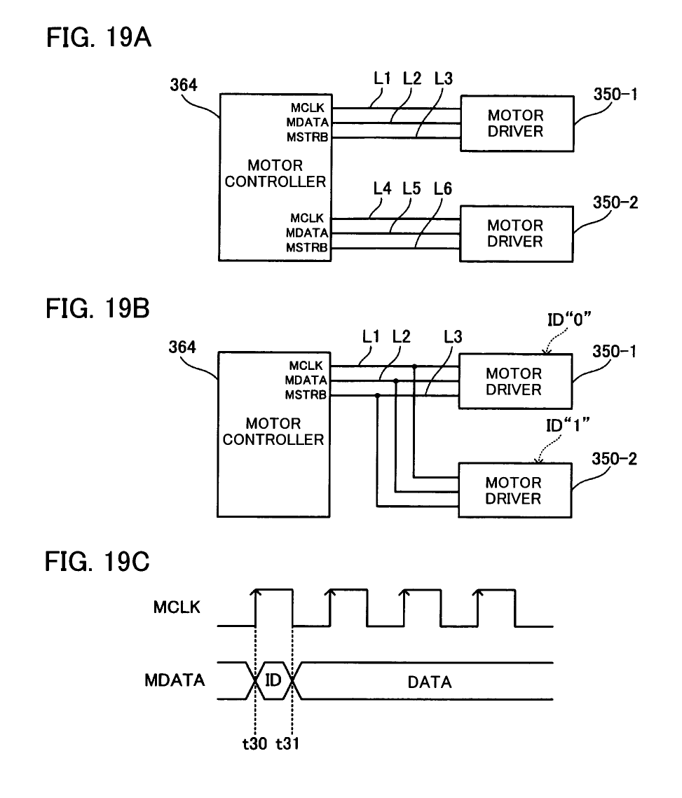

FIGS. 19A, 19B, and 19C are views illustrative of a method whereby the motor controller supplies the motor control signals to a plurality of motor drivers.

FIG. 19A shows the simplest communication configuration. Three signal lines (L1 to L3: these signal lines respectively transmit the signals MCLK, MDATA, and MSTRB) are provided between the motor controller 364 and a motor driver 350-1, and three signal lines (L4 to L6) are similarly provided between the motor controller 364 and a motor driver 350-2. This communication configuration results in an increase in the number of signal lines and cost.

In FIG. 19B, the motor controller 364 supplies the motor control signals (MCLK, MDATA, and MSTRB) to each of the motor drivers 350-1 and 350-2 using common signal lines (L1 to L3).

An identification number (ID) is assigned in advance to each of the motor drivers 350-1 and 350-2. In this embodiment, the identification number (ID) of the motor driver 350-1 is “1”, and the identification number (ID) of the motor driver 350-2 is “1”.

When the motor controller 364 transmits the motor table data (MDATA), the motor controller 364 adds the identification number (ID) to the head of the motor table data (MDATA) and transmits the resulting motor table data (MDATA). In FIG. 19C, the identification number (ID) is transmitted at a time t30, and the motor table data (MDATA) is transmitted at a time t31.

When the identification number (ID) is “0”, the motor driver 350-1 buffers the motor table data (MDATA) transmitted in synchronization with the motor clock signal (MCLK), and captures the buffered data based on the timing of the motor strobe signal (MSTRB).

The number of signal lines between the motor controller and the motor drivers can be reduced by employing the communication configuration shown in FIGS. 19B and 19C, whereby cost can be reduced.

As described above, at least one embodiment of the invention can increase the added value of an analog front-end circuit by positively incorporating the functions of other circuits in the analog front-end circuit, for example. Moreover, it is possible to easily deal with a demand for mounting an image sensor and a motor driver on a circuit board provided with an analog front-end circuit, for example. Furthermore, it is possible to reduce the number of signal lines of a communication cable, thereby reducing the size and thickness of a scanner device.

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

Any term cited with a different term having a broader meaning or the same meaning at least once in the specification and the drawings can be replaced by the different term in any place in the specification and the drawings. The configurations and the operations of the analog front-end circuit and the electronic instrument are not limited to those described in the above embodiments. Various modifications and variations may be made.

Although only some embodiments of the invention have been described above in detail, those skilled in the art would readily appreciate that many modifications are possible in the embodiments without materially departing from the novel teachings and advantages of the invention. Accordingly, such modifications are intended to be included within the scope of the invention.

What is claimed is:

1. An integrated circuit device comprising:
an analog signal processing section that performs signal processing on an analog image signal output from an image sensor and outputs an analog image signal;
an A/D converter that converts the analog image signal output from the analog signal processing section into a digital image signal;
a timing generator that generates and outputs a plurality of control signals; and
at least one memory that stores setting data that is necessary for the timing generator to generate each of the plurality of control signals,
the timing generator generating a control signal of the image sensor among the plurality of control signals based on image sensor setting data stored in the at least one memory, and generating a control signal of a motor driver among the plurality of control signals based on motor driver setting data stored in the at least one memory, the motor driver driving a motor that changes a relative positional relationship between the image sensor and an imaging target.

2. The integrated circuit device as defined in claim 1, the timing generator controlling a drive timing of the image sensor and a drive timing of the motor driver using a reference timing signal transmitted from a host as a reference timing.

3. The integrated circuit device as defined in claim 1,
the timing generator generating a shift pulse based on timing setting information that is included in the image sensor setting data and is based on a reference timing signal transmitted from a host, the shift pulse causing a charge stored in a light-receiving section of the image sensor to be shifted to a transfer section; and
the timing generator generating a driving clock signal for the image sensor in a driving clock signal generation period, the driving clock signal generation period being set based on the timing setting information based on the reference timing signal.

4. The integrated circuit device as defined in claim 1, the integrated circuit device further including:
a motor driver interface,
the timing generator reading the motor driver setting data from the at least one memory using a request signal that is synchronized with a reference timing signal transmitted from a host; and
the motor driver interface supplying transfer data based on the motor driver setting data read from the at least one memory, a transfer clock signal that is used to transfer the transfer data, and a motor strobe signal that provides a capture timing of the transfer data to the motor driver.

5. The integrated circuit device as defined in claim 1, the timing generator controlling a plurality of the motor drivers, the timing generator adding identification information of one of the plurality of motor drivers to the motor driver setting data read from the at least one memory and outputting the resulting motor driver setting data to each of the plurality of motor drivers.

6. The integrated circuit device as defined in claim 1, when a direction from a first side of the integrated circuit device toward a second side of the integrated circuit device opposite to the first side is referred to as a first direction and a direction perpendicular to the first direction is referred to as a second direction, the analog signal processing section, the A/D converter, and a host interface that performs an interface process with a host being disposed along the first direction, and a logic circuit including the timing generator being disposed in the second direction with respect to the analog signal processing section.

7. The integrated circuit device as defined in claim 6, a motor driver interface that outputs a signal to the motor driver being disposed in the second direction with respect to the timing generator.

8. The integrated circuit device as defined in claim 6, a noise transmission prevention shield area being provided between the analog signal processing section and the logic circuit and between the A/D converter and the logic circuit.

9. The integrated circuit device as defined in claim 6,
a terminal that is provided with the analog image signal from the image sensor and a plurality of terminals that output the control signal of the image sensor to the image sensor being disposed on the first side; and
a terminal that outputs a signal from the host interface to the host being disposed on the second side.

10. The integrated circuit device as defined in claim 9, terminals among the plurality of terminals that output the control signal of the image sensor being disposed along the first side, and the remaining terminals among the plurality of terminals that output the control signal of the image sensor being disposed along a third side or a fourth side that is perpendicular to the first side and the second side.

11. A circuit board, the integrated circuit device as defined in claim 1, an image sensor, and a motor driver being mounted on the circuit board.

12. The circuit board as defined in claim 11,
the integrated circuit device and the motor driver being mounted on a front surface of the circuit board; and
the image sensor being mounted on a back surface of the circuit board.

13. An electronic instrument comprising:
a circuit board that includes the integrated circuit device as defined in claim 1, an image sensor that is controlled by the control signal output from the integrated circuit device, and at least one motor driver;
at least one motor that is driven by the at least one motor driver, the at least one motor changing a relative positional relationship between the image sensor and an imaging target; and
a host board that includes an image processing section and supplies a reference timing signal to the integrated circuit device, the image processing section processing the digital image data output from the integrated circuit device.
